(19) United States
(12) Patent Application Publication
(10) Pub. No.: US 2004/0125411 A1
(43) Pub. Date: Jul. 1, 2004

(54) Method of, apparatus for image processing, and computer product

(76) Inventors: Kazunari Tonami, Kanagawa (JP); Etsuo Morimoto, Tokyo (JP); Hiroyuki Shibaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/666,246

(22) Filed: Sep. 22, 2003

(30) Foreign Application Priority Data
Sep. 19, 2002 (JP) 2002-274107

(51) Int. Cl. H04N 1/58; H04N 1/409; H04N 1/60; G06T 5/00

(52) U.S. Cl. 358/2.1; 358/518; 358/3.24; 358/3.27; 382/261; 358/3.26; 358/532; 358/533

(57) ABSTRACT

A scanning unit reads an original color image and outputs an rgb signal of the color image. A scanner γ correction unit that converts the rgb signal from the scanning unit into an RGB signal that is a density signal. A color converting unit converts the RGB signal into a CM signal. An edge amount calculating unit calculates an edge amount from the CM signal. A filter processing unit performs an adaptive filtering process for the RGB signal based on the edge amount.

### BACKGROUND OF THE INVENTION

1) Field of the Invention

The present invention relates to a technology for image processing.

2) Description of the Related Art

In general, digital color photocopying machines apply an edge enhancement for improving sharpness of a character and a smoothing process for suppressing a halftone moire to image signals read by a color scanner. In order to maintain the consistency between the character sharpness and the halftone moire suppression, it is necessary to first extract image attributes and carry out an adaptive process, based on the extracted attributes, by switching between edge enhancement and smoothing or, alternatively, changing a degree of the edge enhancement.

With a conventional technology, an edge amount is calculated from a luminance signal and an adaptive brightness/chrominance difference space filter processing is carried out on the color image signal based on the calculated edge amount. Such a technology is well disclosed in, for example, Japanese Patent Laid-Open Publication No. H10-42152. However, in the case of color character-on-color background where the value of brightness in the background is similar to the brightness of the color character, the edge amount cannot be determined and hence, edge enhancement cannot be carried out.

In another technology disclosed in Japanese Patent Laid-Open Publication No. H7-307869, a luminance signal L* and chromaticity signals a* and b* are used for distinguishing character areas from pattern areas. In yet another technology disclosed in Japanese Patent Laid-Open Publication No. 2000-278542, a luminance edge is determined from a luminance signal Y and a color edge is determined from color signals Cr and Cb.

Generally, in a color scanner, an optical filter separates a reflected light from an original image into three basic colors RGB, namely, red, green and blue. A line sensor, which is formed from a charge-coupled device (CCD), reads each of the color lights. Consequently, the characteristic of the signal output from the scanner is determined according to the spectral sensitivity of the optical filter. FIG. 15 illustrates spectral sensitivity of a typical RGB optical filter. As shown in FIG. 15, there is an overlapping of two or three spectral sensitivities at some specific wavelengths. Consequently, a response is output from a couple of colors for a light that has a wavelength in which such overlapping occurs. For instance, when an original green image, which has a spectral characteristic of 480˜600 nanometer, is read by a scanner, only a response in G signal is expected to be output from the scanner as an output signal. However, because of the overlapping, a response is also output in R signal as well as in B signal.

Consequently, even with the methods disclosed in the above first and second patent literatures, which are based on a chrominance difference (chromaticity), low frequency components due to the Rosetta pattern appear in the chrominance difference signals in an original color halftone image because of low precision of color separation of the signals output from the scanner. As a result, when an edge is detected in a character part on a color halftone, a comparatively large edge amount is detected even in a halftone dot and the low frequency components due to the Rosetta pattern appear in the edge amount of the halftone dot. This unevenness of edge enhancement results in a worsening of graininess. The low frequency components due to the Rosetta pattern also cause an error in judgment during halftone dot separation.

### SUMMARY OF THE INVENTION

It is an object of the present invention to solve at least the problems in the conventional technology.

The image processing apparatus according to one aspect of the present invention includes an input unit that acquires a RGB signal corresponding to a color image, a conversion unit that converts the RGB signal into a CMY signal, an extraction unit that extracts an image attribute from the CMY signal, and a processing unit that applies, based on the image attribute, an adaptive image processing to the RGB signal.

The image processing apparatus according to another aspect of the present invention includes an input unit that acquires a RGB signal corresponding to a color image, a first conversion unit that converts the RGB signal into a CMY signal, an extraction unit that extracts an image attribute from the CMY signal, a second conversion unit that converts the RGB signal into either of a luminance/chrominance difference signal and a lightness/chromaticity signal, and a processing unit that applies, based on the image attribute, an adaptive image processing to either of the luminance/chrominance difference signal and the lightness/chromaticity signal.

The image processing apparatus according to still another aspect of the present invention includes an input unit that acquires a RGB signal corresponding to a color image, a first extraction unit that extracts a first image attribute from the RGB signal, a conversion unit that converts the RGB signal into a CMY signal, a second extraction unit that extracts a second image attribute from the CMY signal, and a processing unit that applies, based on the first image attribute and the second image attribute, an adaptive image processing to the RGB signal.

The image processing apparatus according to still another aspect of the present invention includes an input unit that acquires a RGB signal corresponding to a color image, a first extraction unit that extracts a first image attribute from the RGB signal, a first conversion unit that converts the RGB signal into a CMY signal, a second extraction unit that extracts a second image attribute from the CMY signal, a second conversion unit that converts the RGB signal into either of a luminance/chrominance difference signal and a lightness/chromaticity signal, and a processing unit that applies, based on the first image attribute and the second image attribute, an adaptive image processing to either of the luminance/chrominance difference signal and the lightness/chromaticity signal.

The image processing apparatus according to still another aspect of the present invention includes an input unit that acquires a RGB signal corresponding to a color image, a first conversion unit that converts the RGB signal into a CMY signal, a second conversion unit that converts the RGB signal into either of a luminance/chrominance difference signal and a lightness/chromaticity signal, a first extraction unit that extracts a first image attribute from the CMY signal, a second extraction unit that extracts a second image attribute from either of the luminance/chrominance difference signal and the lightness/chromaticity signal and a processing unit that applies, based on the first image attribute and the second image attribute, an adaptive image processing to the RGB signal.

The image processing apparatus according to still another aspect of the present invention includes an input unit that acquires a RGB signal corresponding to a color image, a first conversion unit that converts the RGB signal into a CMY signal, a first extraction unit that extracts a first image attribute from the CMY signal, a second conversion unit that converts the RGB signal into either of a luminance/chrominance difference signal and a lightness/chromaticity signal, a second extraction unit that extracts a second image attribute from either of the luminance/chrominance difference signal and the lightness/chromaticity signal, and a processing unit that applies, based on the first image attribute and the second image attribute, an adaptive image processing to either of the luminance/chrominance difference signal and the lightness/chromaticity signal.

The image processing method according to still another aspect of the present invention includes acquiring a RGB signal corresponding to a color image, converting the RGB signal into a CMY signal, extracting an image attribute from the CMY signal, and applying, based on the image attribute, an adaptive image processing to the RGB signal.

The image processing method according to still another aspect of the present invention includes acquiring a RGB signal corresponding to a color image, converting the RGB signal into a CMY signal, converting the RGB signal into either of a luminance/chrominance difference signal and a lightness/chromaticity signal, extracting an image attribute from the CMY signal, and applying, based on the image attribute, an adaptive image processing to either of the luminance/chrominance difference signal and the lightness/chromaticity signal.

The image processing method according to still another aspect of the present invention includes acquiring a RGB signal corresponding to a color image, extracting a first image attribute from the RGB signal, converting the RGB signal into a CMY signal, extracting a second image attribute from the CMY signal, and applying, based on the first image attribute and the second image attribute, an adaptive image processing to the RGB signal.

The image processing method according to still another aspect of the present invention includes acquiring a RGB signal corresponding to a color image, extracting a first image attribute from the RGB signal, converting the RGB signal into a CMY signal, extracting a second image attribute from the CMY signal, converting the RGB signal into either of a luminance/chrominance difference signal and a lightness/chromaticity signal, and applying, based on the first image attribute and the second image attribute, an adaptive image processing to either of the luminance/chrominance difference signal and the lightness/chromaticity signal.

The image processing method according to still another aspect of the present invention includes acquiring a RGB signal corresponding to a color image, converting the RGB signal into a CMY signal, converting the RGB signal into either of a luminance/chrominance difference signal and a lightness/chromaticity signal, extracting a first image attribute from the CMY signal, extracting a second image attribute from either of the luminance/chrominance difference signal and the lightness/chromaticity signal, and applying, based on the first image attribute and the second image attribute, an adaptive image processing to the RGB signal.

The image processing method according to still another aspect of the present invention includes acquiring a RGB signal corresponding to a color image, converting the RGB signal into a CMY signal, converting the RGB signal into either of a luminance/chrominance difference signal and a lightness/chromaticity signal, extracting a first image attribute from the CMY signal, extracting a second image attribute from either of the luminance/chrominance difference signal and the lightness/chromaticity signal, and applying, based on the first image attribute and the second image attribute, an adaptive image processing to either of the luminance/chrominance difference signal and the lightness/chromaticity signal.

The computer product according to still another aspect of the present invention realizes the methods according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of an image processing apparatus according to a first embodiment of the present invention;

FIG. 2 is a block diagram of the edge amount calculating unit shown in FIG. 1;

FIG. 3A to FIG. 3D illustrates a four-direction linear differential filter;

FIG. 4 is a block diagram of the filter processing unit shown in FIG. 1;

FIG. 5 illustrates a smoothing filter;

FIG. 6 illustrates a Laplacian filter;

FIG. 7 is a block diagram of an image processing apparatus according to a second embodiment of the present invention;

FIG. 8 is a block diagram of an image processing apparatus according to a third embodiment of the present invention;

FIG. 9 is a block diagram of the image area separating unit shown in FIG. 8;

FIG. 10 is a block diagram of the filter processing unit shown in FIG. 8;

FIG. 11 is a block diagram of the smoothing unit shown in FIG. 10;

FIG. 12 is a block diagram of an image processing apparatus according to a fourth embodiment of the present invention;

FIG. 13 is a block diagram of an image processing apparatus according to a fifth embodiment of the present invention;

FIG. 14 is a block diagram of the image area separating unit shown in FIG. 13; and

FIG. 15 illustrates spectral sensitivity of a typical RGB optical filter.

### DETAILED DESCRIPTION

Exemplary embodiments of a method, an apparatus, and a computer product according to the present invention are explained with reference to the accompanying drawings. The embodiments are described in the sequence of first embodiment, second embodiment, third embodiment, fourth embodiment, and fifth embodiment. In the following descriptions of embodiments, an image processing apparatus is applied to a color photocopying machine.

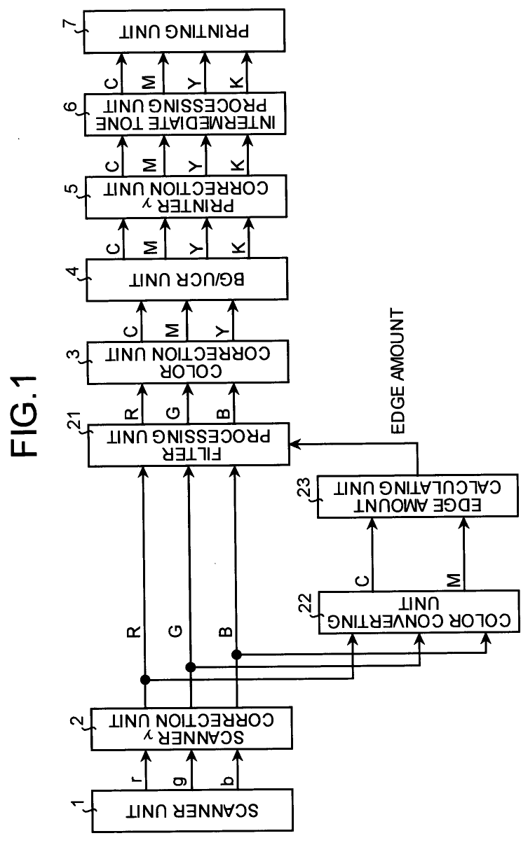

FIG. 1 is a block diagram of an image processing apparatus according to a first embodiment of the present invention. The image processing apparatus comprises a scanning unit 1, a scanner γ correction unit 2, a filter processing unit 21, a color correction unit 3, a BG (black generation)/UCR (undercolor removal) unit 4, a printer γ correction unit 5, an intermediate tone processing unit 6, a printing unit 7, a color converting unit 22, and an edge amount calculating unit 23.

The scanning unit 1 optically reads an original color image and photoelectrically converts the original color image to an 8-bit (0 to 255) digital color image signal. The scanning unit 1 then carries out a widely known shading correction and outputs an rgb (red, green, blue) signal to the scanner γ correction unit 2.

The scanner γ correction unit 2 uses a color look-up table (LUT) or the like and converts the rgb signal received from the scanning unit 1 into an RGB signal, which is a density signal, and outputs the RGB signal to the filter processing unit 21 and the color converting unit 22.

The color converting unit 22 converts the RGB signal received from the scanner γ correction unit 2 into a CMY signal and outputs a C signal and an M signal to the edge amount calculating unit 23. The edge amount calculating unit 23 detects the edge amount of the C signal and the M signal received from the color converting unit 22 and outputs edge amounts of the C signal and the M signal to the filter processing unit 21.

The filter processing unit 21 carries out a filtering process on the RGB signal received from the scanner γ correction unit 2 in accordance with the edge amounts received from the edge amount calculating unit 23, and outputs the post-filter-processed RGB signal to the color correction unit 3.

The color correction unit 3 converts the post-filter-processed RGB signal received from the filter processing unit 21 into the CMY (cyan, magenta, yellow) signal and outputs it to the BG/UCR unit 4. In the color correction unit 3, the color correction process is carried out based on following equations:

C=α11×R+α12×G+α13×B+β1

M=α21×R+α22×G+α23×B+β2

Y=α31×R+α32×G+α33×B+β3 (1)

where α11 through α33 and β1 through β3 are preset color correction coefficients and the output CMY signal is an 8-bit (0 to 255) signal.

The BG/UCR unit 4 generates, based on the CMY signal received from the color correction unit 3, a K signal (BG—black generation) which has a black component, carries out under color removal (UCR) from the CMY signal, and outputs a CMYK signal to the printer γ correction unit 5. In the BG/UCR unit 4, the generation of the K signal and the under color removal from the CMY signal are performed based on following equations:

K=Min (C,M,Y)×β4

C′=C−K×β5

M′=M−K×β5

Y′=Y−K×β5 (2)

where Min(C,M,Y) indicates the minimum values of the CMY signal, β4 and β5 are preset coefficients, and the signal is an 8-bit signal.

The printer γ correction unit 5, with the help of the look-up table, carries out a γ correction process for each color of the received CMYK signal in order to make the colors compatible with the γ attribute of the printer, and outputs the scanner γ-corrected CMYK signal to the intermediate tone processing unit 6.

The intermediate tone processing unit 6 carries out a pseudo halftone process such as the widely known dither process or an error diffusion process and the like on the scanner γ-corrected CMYK signal received from the printer γ correction unit 5, and outputs the pseudo-halftone CMYK signal to the printing unit 7. The printing unit 7 carries out a series of imaging processes on the post-pseudo-halftone CMYK signal received from the intermediate tone processing unit 6.

The color converting unit 22, the edge amount calculating unit 23, and the filter processing unit 21, which are the features of the present invention, are explained in detail next.

The color converting unit 22 converts the RGB signal, which is received after γ correction by the scanner γ correction unit 2, into CM (cyan, magenta) signals and outputs the CM signals to the edge amount calculating unit 23. The conversion from RGB to CM is carried out in accordance with the expression (3) given below.

C=α11′×R+α12′×G+α13′×B+β1′

M=α21′×R+α22′×G+α23′×B+β2′ (3)

where α11′ to α23′ and β1′ and β2′ are preset coefficients.

The optimum value of α11′ to α23′ and β1′ and β2′ in the above expression (3) will also vary according to the hue of the original image. It is not quite possible to use the different coefficients for each type of the original image. Hence, it would be ideal if the values of α11′ to α23′ and β1′ and β2′ could be changed according to the original image type mode (such as, print image mode, photocopy image mode (generation mode), photographic printing paper image mode, etc.) in order to separate the scanner γ-corrected RGB signal with high precision into a CMY signal, which is the processing color of the original image.

For instance, in the case of the print image mode, a coefficient can be used that will yield high color separation precision for a typical printing ink. Alternatively, in the case of the photocopying image mode, a coefficient can be used that will yield high color separation precision for the toner of the photocopying machine. It is also possible to use the coefficients α11 to α23 and β1 and β2 in the expression (1), irrespective of the original image type mode. However, the color separation precision for an original print image will deteriorate.

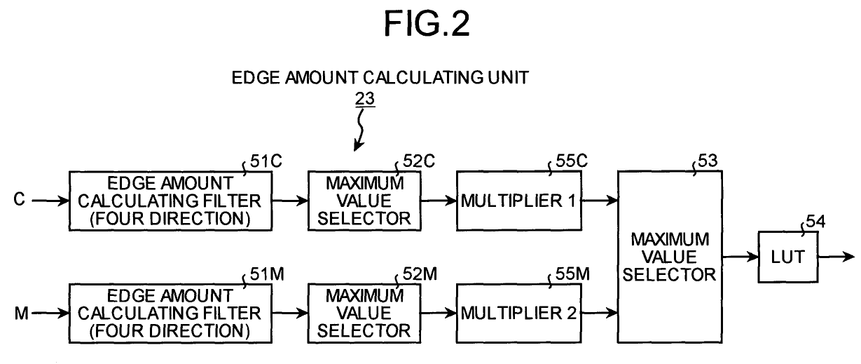

The edge amount calculating unit 23 calculates the edge amount from the CM signals received from the color converting unit 22. FIG. 2 is a block diagram of the edge amount calculating unit 23 shown in FIG. 1. The edge amount calculating unit 23 includes edge amount calculating filters 51C and 51M, maximum value selectors 52C and 52M, constant multipliers 55C and 55M, a maximum value selector 53, and a LUT (look-up table) 54.

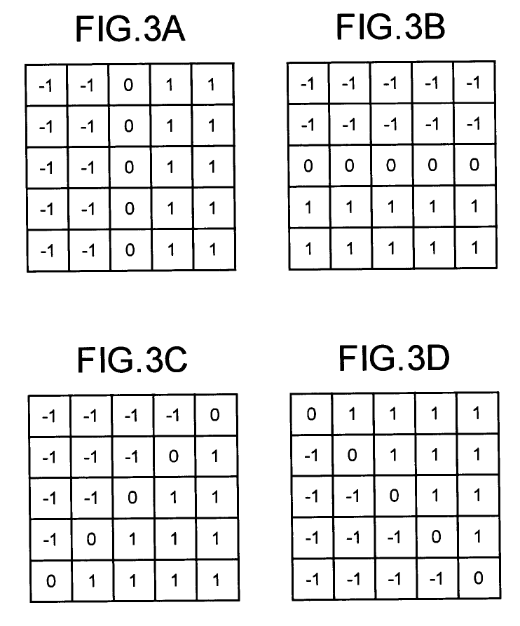

The edge amount calculating filters 51C and 51M have an identical hardware structure. The edge amount calculating filter 51 C and 51M calculate for a C signal and an M signal, respectively, four-direction absolute edge values, as shown in FIG. 3A to FIG. 3D, by a linear differential filtering process.

The maximum value selectors 52C and 52M select a maximum value each of the quadratic edge amounts for the C signal and the M signal, respectively, and output the maximum values of the edge amount to the constant multipliers 55C and 55M. The constant multiplier 55C multiplies the maximum value of the edge amount of the C signal by a constant 1 and outputs the product to the maximum value selector 53. The constant multiplier 55M multiplies the maximum value of the edge amount of the M signal by a constant 2 and outputs the product to the maximum value selector 53. The constants 1 and 2 are constants that are used for adjusting the edge amounts of the C signal and the M signal.

The maximum value selector 53 selects the greater value of the (edge amount of C signal×constant 1) and (edge amount of M signal×constant 2) and outputs the value to the LUT 54.

The LUT 54 converts the (edge amount of C signal×constant 1) value or the (edge amount of M signal×constant 2) value received from the maximum value selector 53 such that the edge amount achieves the desired filtering strength.

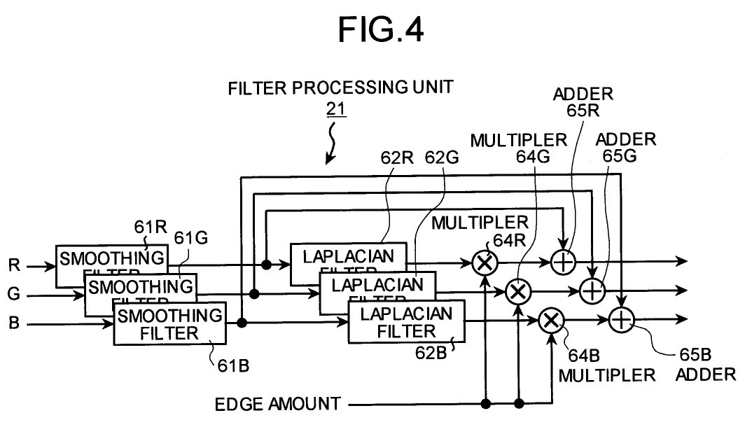

The filter processing unit 21 carries out, based on the edge amount received from the edge amount calculating unit 23, an adaptive filtering process on the RGB signal received from the scanner γ correction unit 2 and outputs the filtered RGB signal to the color correction unit 3. FIG. 4 is a block diagram of the filter processing unit 21 shown in FIG. 1.

The filter processing unit 21 includes smoothing filters 61R, 61G, and 61B, Laplacian filters 62R, 62G, 62B, multipliers 64R, 64G, 64B, and adders 65R, 65G, 65B.

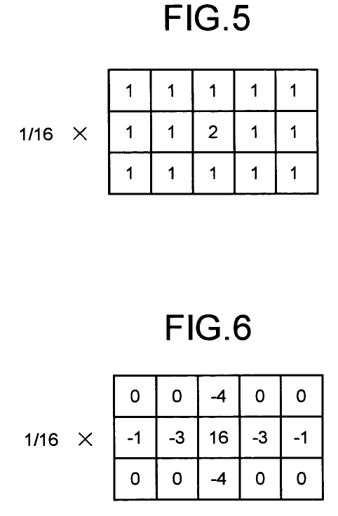

The smoothing filters 61R, 61G, and 61B have an identical hardware structure and carry out, respectively, on the R signal, the G signal, and the B signal input from the scanner γ correction unit 2 the widely known smoothing filtering process by the smoothing filters in the form of the filter coefficients shown in FIG. 5 and output the smoothing-filtered R signal, G signal, and B signal respectively to the Laplacian filters 62R, 62G, 62B and the adders 65R, 65G, 65B.

The Laplacian filters 62R, 62G, and 62B carry out, respectively on the post-smoothing-filtered R signal, G signal, and B signal input from the smoothing filters 61R, 61G, and 61B the widely known Laplacian filtering process by the Laplacian filters in the form of the filter coefficients shown in FIG. 6 and output the filtered R signal, G signal, and B signal respectively to the multipliers 64R, 64G, and 64B.

The multipliers 64R, 64G, and 64B multiply the R, G, B signals input respectively from the Laplacian filters 62R, 62G, and 62B with the edge amount input from the edge amount calculating unit 23 and output the resulting product respectively to the adders 65R, 65G, and 65B.

The adders 65R, 65G, and 65B add the output from the multipliers 64R, 64G, and 64B and the output from the smoothing filters 61R, 61G, and 61B, and output the resulting value to the color correction unit 3.

To sum up, according to the first embodiment of the present invention, the color converting unit 22 converts the RGB signal to the CMY signal. The edge amount calculating unit 23 calculates from the CM signals, which have a high color separation precision, the edge amount as the image attribute. The filter processing unit 21 carries out, based on the edge amount, an adaptive filter process on the RGB signal. Consequently, an increased edge amount for color character-on-color background can be obtained as compared to the edge amount calculated from the scanner γ-corrected RGB signal (or the luminance signal or the chrominance difference signal) that has a low precision of color separation. As a result, sufficient edge enhancement can be achieved.

To be more specific, in the scanner γ-corrected RGB signal, when green characters are on a red background, the background, apart from the red signal, has other color signals as well. Similarly, the characters, apart from the green signal, have other color signals as well. Therefore, even if the edge amount is extracted from the chrominance difference signals, it may not sufficient. On the contrary, in the CM signals, when magenta characters are on a cyan background, the background has only C signal (the level of M signal is practically negligible) and the characters have only M signal (the level of C signal is practically negligible). Therefore, it is as if magenta characters are on a white background and, as a result, sufficient edge amount can be extracted.

Further, in the first embodiment, the Y signal is not used while calculating the edge amount, although it may be used for calculating the edge amount. If the Y signal is used, an edge amount calculating filter 51 for Y signal, and a maximum value selector 52 for Y signal would be required in FIG. 2. However, generally, the Y signal is of a bright color and therefore the requirement for edge enhancement for visualization is considered low. Hence, CM signals are sufficient for the calculation of the edge amount.

Further, in the first embodiment, the edge amount of C signal and the M signal is calculated independently. However, it is also possible to combine the C and M signals, or C, M, and Y signals, and calculate the edge amount from a single signal using signals such as (C+M)/2, max (C,M,Y). In this case, however, the precision is inferior to the method in which the edge amount is calculated for individual signals. However, the hardware requirement can be reduced as only a single circuit is necessary for the edge amount calculation.

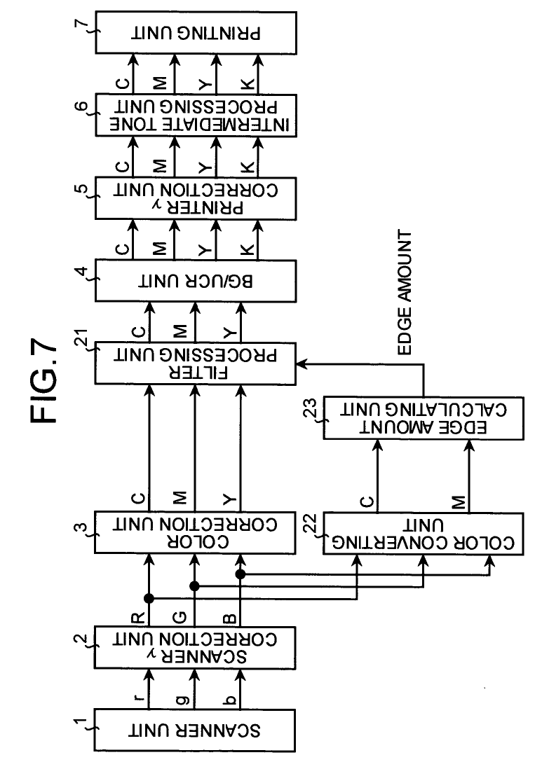

The image processing apparatus according to a second embodiment of the present invention is explained next with reference to the block diagram shown in FIG. 7. The second embodiment has the same components as the first embodiment shown in FIG. 1. However, the positions of the color correction unit 3 and the filter processing unit 21 are interchanged in the second embodiment. In the first embodiment, filtering process is carried out for the RGB signal. However, in the second embodiment, filtering process is carried out for the CMY signal.

A color correction unit 3 converts the RGB signal received from the scanner γ correction unit 2 into the CMY signal and outputs the CMY signal to the filter processing unit 21. While the conversion from the RGB signal to the CMY signal by the color correction unit 3 is carried out so that the colors match with the color reproduction range of the output printer, the conversion from the RGB signal to the CMY signal by a color converting unit 22 is carried out so that a low precision color separation signal such as the RGB signal is converted to a high precision color separation signal such as the CMY signal.

The filter processing unit 21 carries out, based on an edge amount input from an edge amount calculating unit 23, an adaptive filtering processing on the CMY signal received from the color correction unit 3, and outputs the filtered CMY signal to a BG/UCR unit 4.

Consequently, in the image processing apparatus according to the second embodiment also, the edge amount is calculated not from the CM signals output from the color correction unit 3, but from the CM signals output from the color converting unit 22. As a result, a highly precise edge amount can be obtained.

Further, as explained in the first embodiment, at the risk of deterioration of color separation precision, the conversion coefficients α11 to α23 and β1 and β2 in the expression (1) can be used irrespective of the original image type mode. In this case, the color converting unit 22 and the color correction unit 3 in FIG. 7 can be combined into one. Therefore, the hardware requirement is reduced since only one circuit is required for the conversion of the RGB signal to the CMY signal.

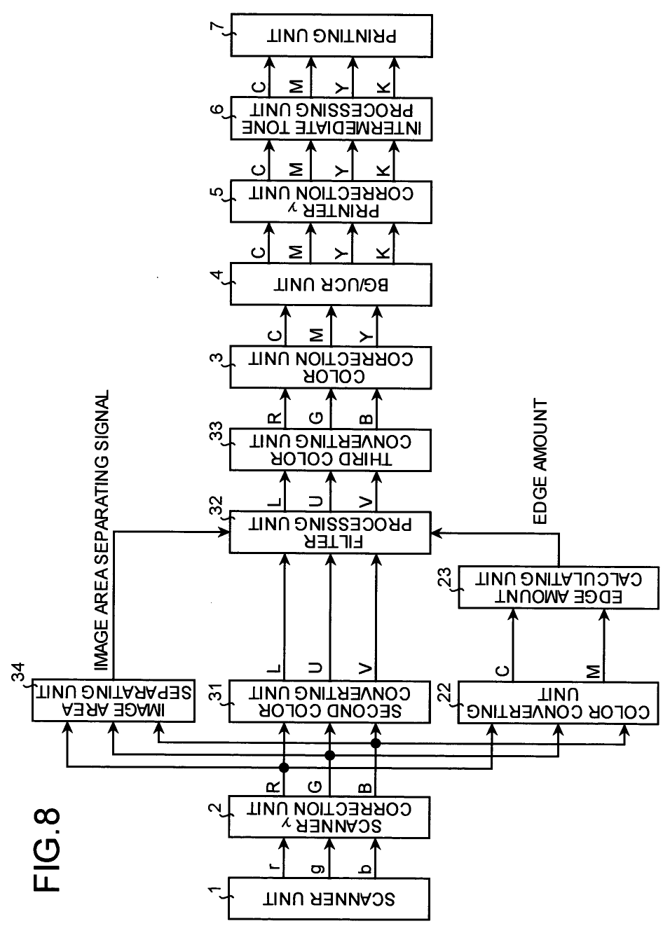

The image processing apparatus according to a third embodiment of the present invention is explained next with reference to FIG. 8 through FIG. 11. FIG. 8 is a block diagram of an image processing apparatus according to a third embodiment of the present invention. The image processing apparatus shown in FIG. 8 has a second color converting unit 31, a third color converting unit 33, and an image area separating unit 34 in addition to the parts in the image processing apparatus shown in FIG. 1. The parts in FIG. 8 that are identical to the parts in FIG. 1 are assigned the same reference numerals except for the filter processing unit which is assigned the reference numeral 21 in FIG. 1 but is denoted by the reference numeral 32 in FIG. 8. Only the parts that are peculiar to the third embodiment, namely, the second color converting unit 31, the third color converting unit 33, the filter processing unit 32, and the image area separating unit 34 are explained in this section.

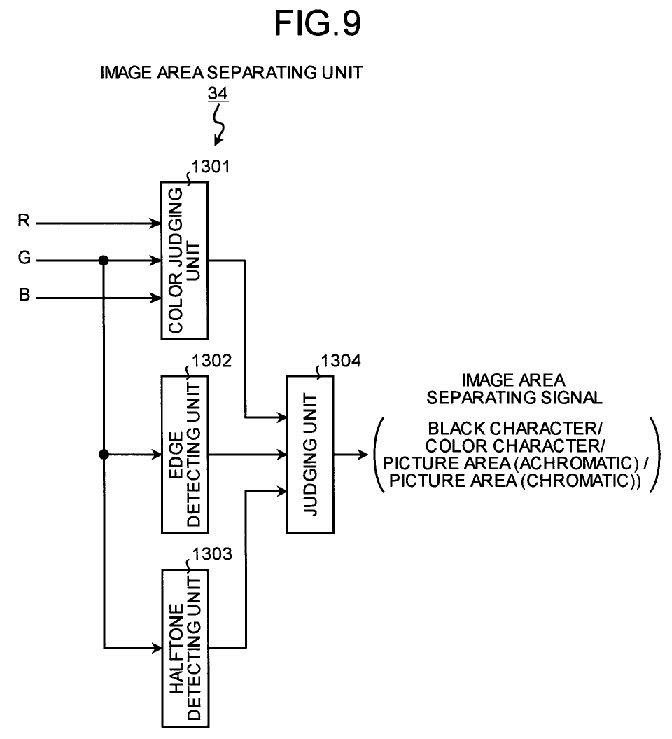

FIG. 9 is a block diagram of the image area separating unit 34 shown in FIG. 8. The image area separating unit 34 comprises a color judging unit 1301, an edge detecting unit 1302, a halftone detecting unit 1303, and a judging unit 1304.

The color judging unit 1301 decides, based on the RGB signal input from a scanner γ correction unit 2, if a pixel (or a block) of interest is a black (achromatic) pixel or a color (chromatic) pixel and outputs the result to the judging unit 1304. To be more specific, the color judging unit 1301 decides a pixel to be achromatic when, for instance, R is greater than Thr 1, G is greater than Thr 2, and B is greater than Thr 3. The pixel is considered to be chromatic otherwise.

The edge detecting unit 1302 decides, based on the G signal input from the scanner γ correction unit 2, if the pixel (or the block) of interest has an edge and outputs the result to the judging unit 1304. The halftone detecting unit 1303 decides, based on the G signal input from the scanner γ correction unit 2, if the pixel (or the block) of interest has a halftone and outputs the result to the judging unit 1304. The deciding method, for instance, may employ the technology disclosed in the article titled “Image area separating method for graphics containing characters and images (halftone, picture)” in Vol. J75-D-II No. 1 pp. 39 to 47, January 1992 issue of Electronic Information Communication Society, wherein edge detection is carried out based on the continuity of high density level and low density level pixels, and the halftone detection is carried out based on the number of peak pixels in a specific area.

The judging unit 1304 decides, based on the results received from the color judging unit 1301, the edge detecting unit 1302, and the halftone detecting unit 1303, if the pixel (or the block) of interest is a black character/color character/picture area (achromatic)/picture area (chromatic), and outputs the result to the filter processing unit 32.

To be more specific, if the pixel or the block is determined to be an ‘edge’ or a ‘non-halftone’, then the judging unit 1304 decides that the pixel is a ‘character’. Otherwise, the pixel is a ‘picture area’. This judgment is combined with the result of the color decision (chromatic/achromatic). If the combination is ‘character’ and ‘chromatic’, then the pixel is judged to be a ‘color character’. If the combination is ‘character’ and achromatic’, then the pixel is judged to be a ‘black character’. Similarly, if the combination is ‘picture area’ and ‘chromatic’, the pixel is judged to be a ‘picture area (chromatic)’, and if the combination is ‘picture area’ and ‘achromatic’, the pixel is judged to be a ‘picture area (achromatic)’.

The second color converting unit 31 converts the RGB signal into an LUV signal (L is a luminance signal, UV is a chrominance difference signal), which is a luminance/chrominance difference signal, and outputs the LUV signal to the filter processing unit 32. The conversion from the RGB signal to the LUV signal is carried out based on the following expressions:

L=floor{(R+2×G+B)/4}

U=R−G

V=B−G (4)

where floor { } is a floor function.

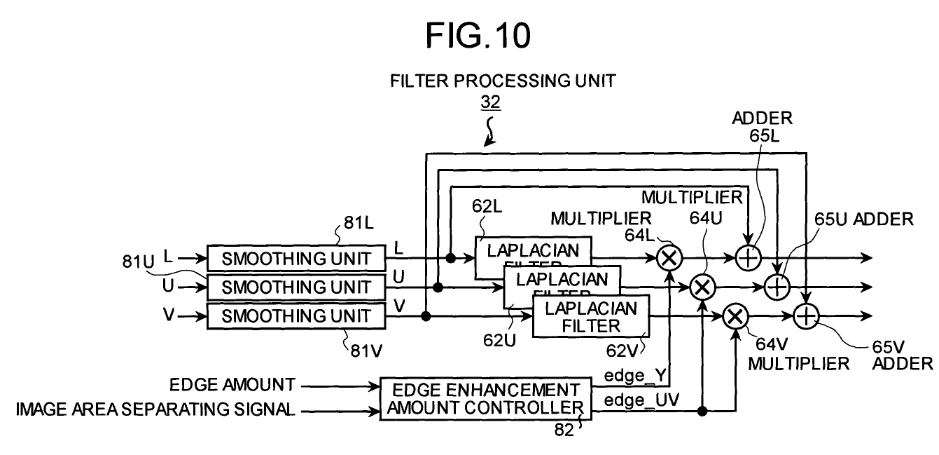

The filter processing unit 32 receives the LUV signal from the second color converting unit 31, an edge amount from an edge amount calculating unit 23, and an image area separating signal from the image area separating unit 34. FIG. 10 is a block diagram of the filter processing unit 32 shown in FIG. 8.

The filter processing unit 32 comprises smoothing units 81L, 81U, 81V, Laplacian filters 62L, 62U, 62V, multipliers 64L, 64U, 64V, adders 65L, 65U, 65V, and an edge enhancement amount controller 82.

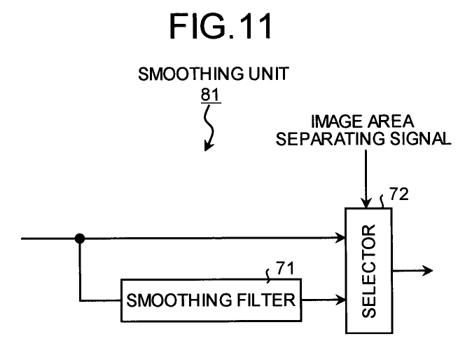

The smoothing units 81L, 81U, and 81V carry out a smoothing process on the LUV signal input from the second color converting unit 31 and output the smoothed LUV signal respectively to the Laplacian filters 62L, 62U, and 62V. FIG. 11 is a block diagram of the smoothing unit 81L/81U/81V shown in FIG. 10. As the smoothing units 81L, 81U, and 81V have the same hardware structure, they are represented as a smoothing unit 81 in FIG. 11. The smoothing unit 81 comprises a smoothing filter 71 and a selector 72.

The LUV signal from the second color converting unit 31 are input to the smoothing filter 71 and the selector 72 in the smoothing unit 81 shown in FIG. 11. The smoothing filter 71 carries out a smoothing process on the LUV signal received from the color converting unit 31 and outputs the smoothed LUV signal to the selector 72.

The selector 72 selects, based on the image area separating signal input from the image area separating unit 34, either the LUV signal prior to the smoothing process (non-smoothed signal) input from the second color converting unit 31 or the smoothed LUV signal input from the smoothing filter 81, and outputs the selected LUV signal to the respective Laplacian filter 62 and adder 65. To be more specific, the selector 72 selects the LUV signal prior to the smoothing process if the image area separating signal indicates a black character/color character, and the smoothed LUV signal if the image area separating signal indicates a picture area.

The Laplacian filters 62L, 62U, and 62V carry out a Laplacian filtering process on the L, U, and V signals input respectively from the smoothing units 81L, 81U, and 81V, and output the Laplacian filtered L, U, and V signals, respectively, to the multipliers 64L, 64U, and 64V.

The edge enhancement amount controller 82 calculates, based on the edge amount input from the edge amount calculating unit 23 and the image area separating signal input from the image area separating unit 34, a luminance enhancement amount (edge_Y) and a chrominance difference enhancement amount (edge_UV). The edge enhancement amount controller then outputs the luminance enhancement amount (edge_Y) to the multiplier 64L, and the chrominance difference enhancement amount (edge_UV) to the multipliers 64U and 64V. To be more specific, the luminance enhancement amount (edge_Y) and the chrominance difference enhancement amount (edge_UV) are calculated in accordance with the expression (5) given below.

| Black character | edge_Y = const, edge_UV = 0 | |
|---|---|---|
| Color character | edge_Y = 0, edge_UV = const | |
| Picture area | edge_Y = Eout, edge_UV = 0 | |
| (achromatic) | | |
| Picture area | edge_Y = 0, edge_UV = Eout | |
| (chromatic) | | |
| | | . . . (5) |

where, Eout is the edge amount output from the edge amount calculating unit 23, and const is a value determining the degree of enhancement of the character. Normally, const is the maximum Eout value (or a value excluding the maximum Eout value).

According to expression (5), for a black character, only the luminance is greatly enhanced and for a color character, only the chrominance difference is greatly enhanced. For a picture area, edge enhancement is carried out in either luminance or the chrominance difference in accordance with the edge amount, based on whether the picture area is achromatic or chromatic.

The multiplier 64L multiplies the L signal input from the Laplacian filter 62L and the luminance enhancement amount (edge_Y) input from the edge enhancement amount controller 82, and outputs the product to the adder 65L. The multiplier 64U and 64V multiply the U signal and V signal input respectively from the Laplacian filters 62U and 62V with the chrominance difference enhancement amount (edge_UV) input from the edge enhancement amount controller 82, and output the products respectively to the multiplier 65U and 65V.

The adders 65L, 65U, and 65V add output from the multipliers 64L, 64U, 64V and output from the smoothing units 81L, 81U, 81V, respectively, and output the results to the third color converting unit 33

The third color converting unit 33 converts the LUV signal input from the filter processing unit 32 into an RGB signal in accordance with the expression (6) given below, and outputs the RGV signal to a color correction unit 3.

G=L-floor {(U+V)/4}

R=U+G

B=V+G (6)

In the expressions (5) and (6), the floor function has been used. However, the floor function need not necessarily be used in the space filter process. Instead rounding or truncating may be implemented.

To sum up, according to the third embodiment of the present invention, the filter processing unit 32 carries out, based on the edge amount calculated from the CM signals and the image area signal calculated from the RGB signal, luminance/chrominance difference enhancement on the LUV signal. Consequently, pure black characters in which no color is included and pure color characters can be obtained. Further, the edge amount is calculated from the CM signals, as in the first embodiment. As a result, the edge amount in the case of color character-on-color background can be increased as compared to the case in which the edge amount is calculated from the RGB signal obtained after the scanner γ correction process (or from the edge amount calculated from the luminance (brightness)/chrominance difference signal calculated from the RGB signal).

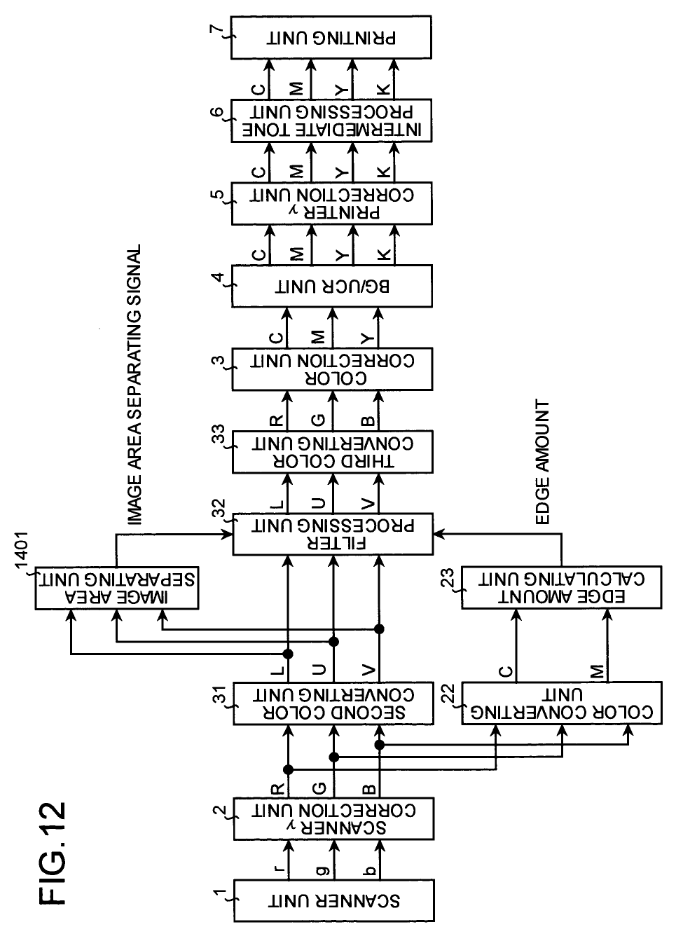

The image processing apparatus according to a fourth embodiment of the present invention is explained next with reference to FIG. 12. FIG. 12 is a block diagram of an image processing apparatus according to a fourth embodiment of the present invention. The image processing apparatus shown according to the fourth embodiment has an image area separating unit 1401 that employs a luminance chrominance difference signal, namely the LUV signal, instead of the RGB signal that is employed by the color processing apparatus according to the third embodiment shown in FIG. 8.

The image area separating unit 1401 carries out, based on the LUV signal input from a color converting unit 31, an image area separation and outputs the image area separated signal to a filter processing unit 32. The method disclosed in Japanese Patent Laid-Open Publication No.H5-145750 may be employed as an image area separation method that uses the LUV signal. In this method, character/halftone (picture) is decided from L* signal and color/black and white is decided from a*b* signals of L*a*b* signal. Image area separation in the case of a LUV signal is also carried out in the same way as for the L*a*b* signal.

In this way, an effect similar to the one in the third embodiment can be obtained even by combining with the widely known image area separating technology relating to the luminance chrominance difference signal. The image area separation and the filtering process are carried out by the same luminance chrominance difference signal. Hence, a common line memory can be used, thereby reducing the scale of the hardware requirement.

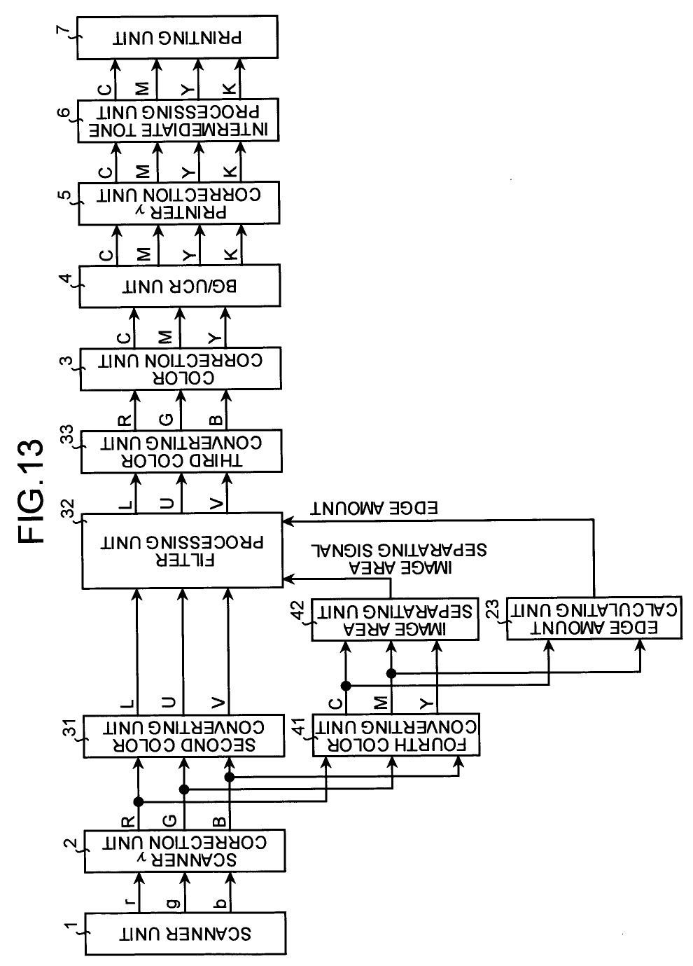

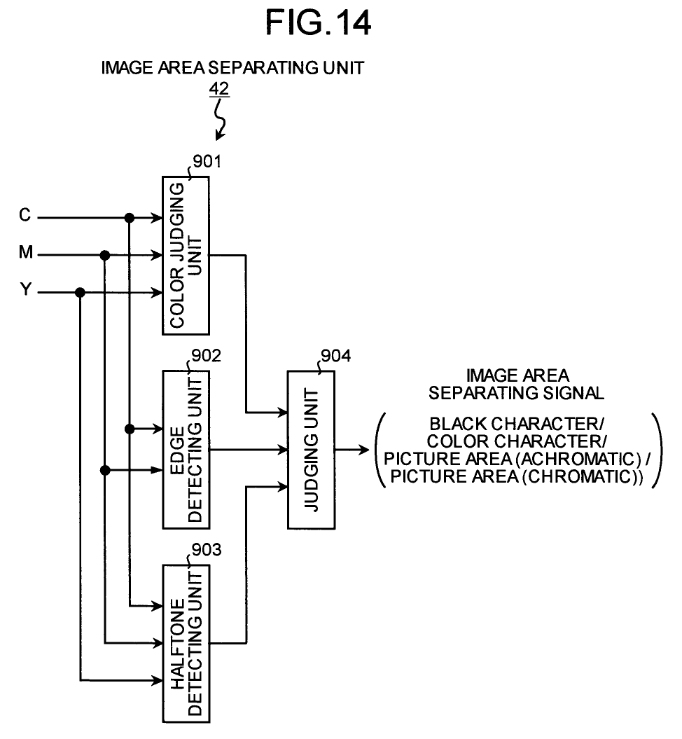

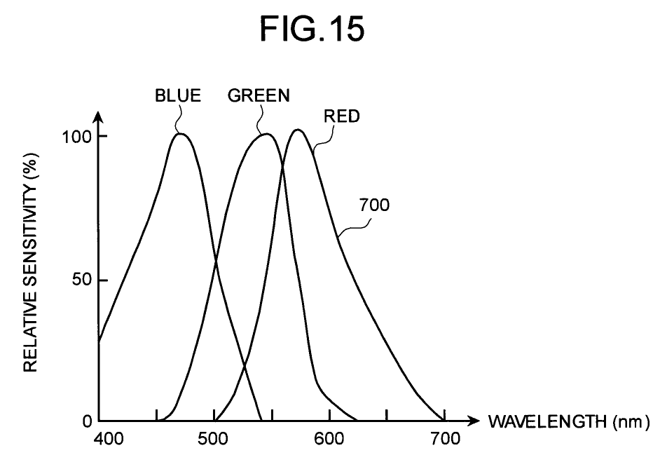

The image processing apparatus according to a fifth embodiment of the present invention is explained next with reference to FIG. 13 and FIG. 14. FIG. 13 is a block diagram of an image processing apparatus according to a fifth embodiment of the present invention. The parts in FIG. 13 that are identical to those in FIG. 1 are assigned the same reference numerals and are not described here. However, the parts that are different (a fourth color converting unit 41 and an image area separating unit 42) in the fifth embodiment are explained here.

The fourth color converting unit 41 converts into a CMY signal a scanner γ-corrected RGB signal input from a scanner γ correction unit 2 and outputs the CMY signal to the image area separating unit 42 and the CM signal to an edge amount calculating unit 23.

The function of the edge amount calculating unit 23 is identical to that in the first embodiment (FIG. 1). Hence, its description is omitted here.

FIG. 14 is a block diagram of the image area separating unit 42 shown in FIG. 13. The image area separating unit 42 comprises a color judging unit 901, an edge detecting unit 902, a halftone detecting unit 903, and a judging unit 904.

The color judging unit 901 judges, based on the RGB signal input from the fourth color converting unit 41, if a pixel (or a block) of interest is a black pixel (achromatic) or a color pixel (chromatic) and outputs the result to the judging unit 904. To be more specific, the color judging unit decides a pixel to be black if C is greater than Thr 1, M is greater than Thr 2, and Y is greater than Thr 3. The pixel is considered to be a color pixel otherwise.

The edge detecting unit 902 decides, based on the CM signal input from the color converting unit 42, if the pixel (or the block) of interest is an edge and outputs the result to the judging unit 904. To be more specific, the edge detecting unit 902 judges by the method employed in the third embodiment (FIG. 9) if the C signal and the M signal have an edge. If an edge is detected in at least one of the C signal and the M signal, the edge detecting unit 902 outputs the result that an edge has been detected. If neither the C signal nor the M signal is an edge, the edge detecting unit 902 outputs the result indicating that no edge has been detected.

The halftone detecting unit 903 decides, based on the CMY signal input from the color converting unit 42, if the pixel (or the block) of interest is a halftone and outputs the result to the judging unit 904. To be more specific, the halftone detecting unit 903 detects by the method employed in the third embodiment, the peak for each of the C, M, and Y signals and decides if it is a halftone. Even if one of the C, M or Y signal is a halftone, the halftone detecting unit 903 outputs the signal indicating that a halftone has been detected. Only if none of the C, M, and Y signals is a halftone does the halftone detecting unit 903 output the signal indicating no halftone has been detected.

The judging unit 904 decides by the method employed in the third embodiment, based on the result of the color judging unit 901, the edge detecting unit 902, and the halftone detecting unit 903, if the pixel (or the block) of interest is a black character/color character/picture area (achromatic)/picture area (chromatic), and outputs the result as a picture area separation signal to a filter processing unit 32.

To sum up, in the fifth embodiment, the image area separating unit 42 carries out image area separation employing a CMY signal. Consequently, high-precision halftone detection is easily carried out. In other words, an original color halftone image is separated into an individual halftone of CMY. As the Rosetta pattern is almost negligible in the CMY signal, the peak detection of this halftone-separated signal can be more easily carried out as compared to image area separation of a RGB signal or a luminance chrominance difference signal. Therefore, errors relating to separation are also minimized.

An error in deciding the color is very likely to occur in a low precision color separation RGB signal. For instance, in an original dark magenta (red+blue) image, not only do the R signal and B signal have high values because of low precision of color separation of the RGB signal, but the G signal also has a relatively high value. Consequently, the image may be incorrectly judged as achromatic. In contrast, in a high precision color separation CMY signal, if the original image is a dark green (cyan+yellow) image, the M and Y signals have high values, but the C signal has a small value. Consequently, the image is correctly judged as achromatic. In other words, an accurate decision if a given pixel is chromatic/achromatic can be made by deciding the color in a high precision color separation CMY signal. Further, since image area separation and edge amount calculation take place in the same CMY color space, a common line memory can be used, thereby reducing the scale of the hardware requirement.

In the first through fifth embodiments an adaptive filtering process occurring in an RGB space, a CMY space, and an LUV space is explained. However, the gist of the present invention is that the edge amount is calculated or the image area separation is carried out from a signal converted in the CMY space. The filtering process, however, need not be confined to only the color spaces mentioned above and may include an L*a*b* color space or a YCbCr color space, etc. The filter processing structure (smoothing and enhancing methods) may, for instance, employ the technology disclosed in Japanese Patent Laid-Open Publication No. H10-42152, Japanese Patent Laid-Open Publication No. H7-307869, and Japanese Patent Laid-Open Publication No. 2001-24898.

Further, in the first through fifth embodiments, an example of image data being read by a scanner has been shown. However, image data may also be received via a transmission channel such as a local area network (LAN). The output device may not necessarily be a printer and may be a display device such as a monitor or a storage device such as a hard disk.

The image processing apparatus according to the present invention can be applied to a system constituted by a plurality of devices (for instance, a host computer, an interface, a scanner, and a printer, etc.) or to an apparatus comprising a single device (for instance, a copying machine, a digital multifunction product, or a facsimile machine, etc.).

The object of the present invention can also be achieved by providing a storage medium that stores program codes for performing the aforesaid functions of the embodiment to a system or an apparatus, reads the program codes with a computer (or a central processing unit (CPU), a microprocessor unit (MPU), or a digital signal processor (DSP)) of the system or apparatus from the storage medium, and then executes the program. In this case, the program codes read from the storage medium implement the functions the program codes or the storage medium in which the program codes are stored constitutes the invention. The storage medium on which the program codes is stored can be a magnetic storage medium such as a floppy disk (FD) or a hard disk, an optical storage medium such as an optical disk, a magneto optical storage medium such as a magneto optical disk, CD-ROM, CD-R, or magnetic tape, or a semiconductor storage medium such as a non-volatile type memory card, ROM, etc.

Further, besides the case where the functions of the image processing apparatus are implemented by executing the program codes read by a computer, the present invention covers a case where an operating system (OS) or the like working on the computer performs a part of or the entire process in accordance with the designation of program codes and implements the functions according to the embodiment.

The present invention further covers a case where, after the program codes read from the storage medium are written to a function extension board inserted into the computer or to a memory provided in a function unit connected to the computer, a CPU or the like contained in the function extension board or function extension unit performs a part of or the entire process in accordance with the designation of the program codes and implements the function of the above embodiments.

As many apparently widely different embodiments of the present invention can be made without departing from the spirit and scope thereof, it is to be understood that the invention is not limited to the specific embodiments thereof except as defined in the appended claims.

The image processing apparatus according to claim 1 comprises an image input unit that inputs an RGB signal corresponding to a color image, a first color conversion unit that converts the RGB signal input from the image input unit to a CMY signal, an image attribute extraction unit that extracts an image attribute from the CMY signal, and an adaptive image processing unit that adaptively carries out, in accordance with the image attributes extracted from the CMY signal, image processing of color image signals of the color image. Consequently, highly accurate image attribute can be extracted from the CMY signal that has a high precision of color separation and therefore an adaptive image processing can be carried out.

In the image processing apparatus according to claim 2, the image attribute extraction unit according to claim 1 calculates as the image attribute an edge amount of the color image. Consequently, in addition to the effects of claim 1, a high edge amount can be obtained in a color character-on-color background setup, thereby achieving sufficient edge enhancement.

In the image processing apparatus according to claim 3, the image attribute extraction unit according to the claim 1 calculates as the image attribute an image area separating signal that separates an image area. Consequently, in addition to the effects of claim 1, errors relating to color judgment can be considerably reduced as image area separation is carried out using the CMY signal that has a high precision of color separation. Further, highly accurate halftone separation can also be carried out.

In the image processing apparatus according to claim 4, the adaptive image processing unit according to any one of claims 1 through 3 carries out an adaptive image processing on an RGB signal, or a luminance chrominance difference signal or a brightness chromaticity signal of the color image. Consequently, in addition to effects of any one of claims 1 through 3, the adaptive image processing of the filtering process can be carried out in any color space, as the CMY signal, which is converted in the CMY color space, is used only for extracting the image attribute.

The image processing apparatus according to claim 5 comprises an image input unit that inputs an RGB signal corresponding to a color image, a first image attribute extraction unit that extracts a first image attribute from the RGB signal input from the image input unit, a first conversion unit that converts the RGB signal input from the image input unit into a CMY signal, a second image attribute extraction unit that extracts a second image attribute from the CMY signal, and an adaptive image processing unit that adaptively carries out, based on the first image attribute and the second image attribute, image processing on color image signals of the color image. Consequently, a highly accurate image attribute can be extracted from the CMY signal that has a high precision of color separation and therefore an adaptive image processing can be carried out.

In the image processing apparatus according to claim 6, the first image attribute extraction unit according to claim 5 calculates as the first image attribute an image area separating signal that separates an image area, and the second image attribute extraction unit calculates as the second image attribute an edge amount of the color image. Consequently, in addition to the effects of claim 5, a high edge amount can be obtained in a color character-on-color background setup, thereby achieving sufficient edge enhancement.

In the image processing apparatus according to claim 7, the adaptive image processing unit according to the claim 5 or 6 adaptively carries out image processing on the RGB signal or a luminance chrominance difference or a brightness chromaticity signal of the color image. Consequently, in addition to the effects of claim 5 or 6, the adaptive image processing of the filtering process can be carried out in any color space, as the CMY signal that is converted in the CMY color space is used only for extracting the image attribute.

The image processing apparatus according to the claim 8 comprises an image input unit that inputs an RGB signal corresponding to a color image, a first conversion unit that converts the RGB signal into a CMY signal, a second conversion unit that converts the RGB signal into a luminance chrominance difference signal or a brightness chromaticity signal, a first image attribute extraction unit that extracts a first image attribute from the luminance chrominance difference signal or the brightness chromaticity signal, a second image attribute extraction unit that extracts a second image attribute from the CMY signal, and an adaptive image processing unit that adaptively carries out, based on the first image attribute and the second image attribute, image processing on color image signals. Consequently, highly accurate image attribute can be extracted from the CMY signal that has a high precision of color separation and therefore an adaptive image processing can be carried out.

In the image processing apparatus according to claim 9, the first image attribute extraction unit according to claim 8 calculates as the first image attribute an image area separating signal that separates an image area, and the second image attribute extraction unit calculates as the second image attribute an edge amount of the color image. Consequently, in addition to the effects of claim 8, a high edge amount can be obtained in a color character-on-color background setup, thereby achieving sufficient edge enhancement.

In the image processing apparatus according to claim 10, the adaptive image processing unit according to claim 8 or 9 adaptively carries out image processing of the RGB signal or a luminance chrominance difference signal or a brightness chromaticity signal of the color image. Consequently, in addition to the effects of claim 8 or 9, the adaptive image processing of the filtering process can be carried out in any color space, as the CMY signal that is converted in the CMY color space is used only for extracting the image attribute.

In the image processing apparatus according to claim 11, the second image attribute extraction unit according to claim 6 or 9 calculates as the second image attribute the edge amounts of a C signal or an M signal of the CMY signal. Consequently, in addition to the effects of claim 6 or 9, only the C signal and M signal are employed for calculating the edge amount value, thereby enabling reduction in the scale of the hardware.

In the image processing apparatus according to claim 12, the first color conversion unit according to any one of claims 1 through 11 varies a conversion coefficient for conversion of the RGB signal to the CMY signal in accordance with an original image type mode. Consequently, appropriate conversion coefficient can be used for original images such as a print image and photographic print image that have greatly differing hue characteristics, thereby making the color separation precision high.

In the image processing according to claim 13, the original image type mode is a print image mode, a photographic printing paper image mode, or a photocopy image mode (generation mode). Consequently, in addition to the effects of claim 12, the color separation precision of the CMY signal in the print image mode, the photographic printing paper image mode, or the photocopy image mode (generation mode) can be increased.

The image processing method according to claim 14 comprises the steps of inputting an RGB signal corresponding to a color image, converting the RGB signal into a CMY signal, extracting an image attribute from the CMY signal, and an adaptive image processing of color image signals in accordance with the extracted image attribute. Consequently, highly accurate image attribute can be extracted from the CMY signal that has a high precision of color separation and therefore an adaptive image processing can be carried out.

The program according to claim 15 that causes a computer to execute the steps of inputting an RGB signal corresponding to a color image, converting the RGB signal into a CMY signal, extracting an image attribute from the CMY signal, and an adaptive image processing of color image signals in accordance with the extracted image attribute. Consequently, a highly accurate image attribute can be extracted from the CMY signal that has a high precision of color separation and therefore an adaptive image processing can be carried out.

The present document incorporates by reference the entire contents of Japanese priority document, 2002-274107 filed in Japan on Sep. 19, 2002.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image processing apparatus comprising:
an input unit that acquires a RGB signal corresponding to a color image;
a conversion unit that converts the RGB signal into a CMY signal;
an extraction unit that extracts an image attribute from the CMY signal; and
a processing unit that applies, based on the image attribute, an adaptive image processing to the RGB signal.

2. The image processing apparatus according to claim 1, wherein the extraction unit calculates an edge amount of the color image as the image attribute.

3. The image processing apparatus according to claim 1, wherein the extraction unit generates an image area separating signal that is used to separate an image into a plurality of areas as the image attribute.

4. The image processing apparatus according to claim 1, wherein the conversion unit changes a conversion coefficient for converting the RGB signal into the CMY signal based on a type of the color image.

5. The image processing apparatus according to claim 4, wherein the type of the color image is any one of a print image, a photographic printing paper image, and a photocopy image.

6. An image processing apparatus comprising:
an input unit that acquires a RGB signal corresponding to a color image;
a first conversion unit that converts the RGB signal into a CMY signal;
an extraction unit that extracts an image attribute from the CMY signal;
a second conversion unit that generates a signal including either of a luminance/chrominance difference signal and a lightness/chromaticity signal from the RGB signal; and
a processing unit that applies, based on the image attribute, an adaptive image processing to the signal generated by the second conversion unit.

7. The image processing apparatus according to claim 6, wherein the extraction unit calculates an edge amount of the color image as the image attribute.

8. The image processing apparatus according to claim 6, wherein the extraction unit generates an image area separating signal that is used to separate an image into a plurality of areas as the image attribute.

9. The image processing apparatus according to claim 6, wherein the first conversion unit changes a conversion coefficient for converting the RGB signal into the CMY based on a type of the color image.

10. The image processing apparatus according to claim 9, wherein the type of the color image is any one of a print image, a photographic printing paper image, and a photocopy image.

11. An image processing apparatus comprising:
an input unit that acquires a RGB signal corresponding to a color image;
a first extraction unit that extracts a first image attribute from the RGB signal;
a conversion unit that converts the RGB signal into a CMY signal;
a second extraction unit that extracts a second image attribute from the CMY signal; and
a processing unit that applies, based on the first image attribute and the second image attribute, an adaptive image processing to the RGB signal.

12. The image processing apparatus according to claim 11, wherein
the first extraction unit generates an image area separating signal that is used to separate an image into a plurality of areas as the first image attribute, and
the second extraction unit calculates an edge amount of the color image as the second image attribute.

13. The image processing apparatus according to claim 12, wherein the second extraction unit calculates the edge amount from a C signal and an M signal of the CMY signal as the second image attribute.

14. The image processing apparatus according to claim 11, wherein the conversion unit changes a conversion coefficient for converting the RGB signal into the CMY signal based on a type of the color image.

15. The image processing apparatus according to claim 14, wherein the type of the color image is any one of a print image, a photographic printing paper image, and a photocopy image.

16. An image processing apparatus comprising:
an input unit that acquires a RGB signal corresponding to a color image;
a first extraction unit that extracts a first image attribute from the RGB signal;
a first conversion unit that converts the RGB signal into a CMY signal;
a second extraction unit that extracts a second image attribute from the CMY signal;
a second conversion unit that generates a signal including either of a luminance/chrominance difference signal and a lightness/chromaticity signal from the RGB signal; and
a processing unit that applies, based on the first image attribute and the second image attribute, an adaptive image processing to the signal generated by the second conversion unit.

17. The image processing apparatus according to claim 16, wherein
the first extraction unit generates an image area separating signal that is used to separate an image into a plurality of areas as the first image attribute, and
the second extraction unit calculates an edge amount of the color image as the second image attribute.

18. The image processing apparatus according to claim 17, wherein the second extraction unit calculates the edge amount from a C signal and an M signal of the CMY signal as the second image attribute.

19. The image processing apparatus according to claim 16, wherein the first conversion unit changes a conversion coefficient for converting the RGB signal into the CMY based on a type of the color image.

20. The image processing apparatus according to claim 19, wherein the type of the color image is any one of a print image, a photographic printing paper image, and a photocopy image.

21. An image processing apparatus comprising:
an input unit that acquires a RGB signal corresponding to a color image;
a first conversion unit that converts the RGB signal into a CMY signal;
a first extraction unit that extracts a first image attribute from the CMY signal;
a second conversion unit that generates a signal including either of a luminance/chrominance difference signal and a lightness/chromaticity signal from the RGB signal;
a second extraction unit that extracts a second image attribute from the signal generated by the second conversion unit; and
a processing unit that applies, based on the first image attribute and the second image attribute, an adaptive image processing to the RGB signal.

22. The image processing apparatus according to claim 21, wherein
the first extraction unit calculates an edge amount of the color image as the first image attribute, and
the second extraction unit generates an image area separating signal that is used to separate an image into a plurality of areas as the second image attribute.

23. The image processing apparatus according to claim 22, wherein the first extraction unit calculates the edge amount from a C signal and an M signal of the CMY signal as the second image attribute.

24. The image processing apparatus according to claim 21, wherein the first conversion unit changes a conversion coefficient for converting the RGB signal into the CMY signal based on a type of the color image.

25. The image processing apparatus according to claim 24, wherein the type of the color image is any one of a print image, a photographic printing paper image, and a photocopy image.

26. An image processing apparatus comprising:
an input unit that acquires a RGB signal corresponding to a color image;
a first conversion unit that converts the RGB signal into a CMY signal;
a first extraction unit that extracts a first image attribute from the CMY signal;
a second conversion unit that generates a signal including either of a luminance/chrominance difference signal and a lightness/chromaticity signal from the RGB signal;
a second extraction unit that extracts a second image attribute from the signal generated by the second conversion unit; and
a processing unit that applies, based on the first image attribute and the second image attribute, an adaptive image processing to the signal generated by the second conversion unit.

27. The image processing apparatus according to claim 26, wherein
the first extraction unit calculates an edge amount of the color image as the first image attribute, and
the second extraction unit generates an image area separating signal that is used to separate an image into a plurality of areas as the second image attribute.

28. The image processing apparatus according to claim 27, wherein the first extraction unit calculates the edge amount from a C signal and an M signal of the CMY signal as the second image attribute.

29. The image processing apparatus according to claim 26, wherein the first conversion unit changes a conversion coefficient for converting the RGB signal into the CMY signal based on a type of the color image.

30. The image processing apparatus according to claim 29, wherein the type of the color image is any one of a print image, a photographic printing paper image, and a photocopy image.

31. An image processing method comprising:
acquiring a RGB signal corresponding to a color image;
converting the RGB signal into a CMY signal;
extracting an image attribute from the CMY signal; and
applying, based on the image attribute, an adaptive image processing to the RGB signal.

32. An image processing method comprising:
acquiring a RGB signal corresponding to a color image;
converting the RGB signal into a CMY signal;
extracting an image attribute from the CMY signal; and
generating a signal including either of a luminance/chrominance difference signal and a lightness/chromaticity signal from the RGB signal;
applying, based on the image attribute, an adaptive image processing to the signal including either of a luminance/chrominance difference signal and a lightness/chromaticity signal.

33. An image processing method comprising:
acquiring a RGB signal corresponding to a color image;
extracting a first image attribute from the RGB signal;
converting the RGB signal into a CMY signal;
extracting a second image attribute from the CMY signal; and
applying, based on the first image attribute and the second image attribute, an adaptive image processing to the RGB signal.

34. An image processing method comprising:
acquiring a RGB signal corresponding to a color image;
extracting a first image attribute from the RGB signal;
converting the RGB signal into a CMY signal;
extracting a second image attribute from the CMY signal;
generating a signal including either of a luminance/chrominance difference signal and a lightness/chromaticity signal from the RGB signal; and
applying, based on the first image attribute and the second image attribute, an adaptive image processing to the signal including either of a luminance/chrominance difference signal and a lightness/chromaticity signal.

35. An image processing method comprising:
acquiring a RGB signal corresponding to a color image;
converting the RGB signal into a CMY signal;
extracting a first image attribute from the CMY signal;
generating a signal including either of a luminance/chrominance difference signal and a lightness/chromaticity signal from the RGB signal;
extracting a second image attribute from the signal including either of a luminance/chrominance difference signal and a lightness/chromaticity signal; and
applying, based on the first image attribute and the second image attribute, an adaptive image processing to the RGB signal.

36. An image processing method comprising:
acquiring a RGB signal corresponding to a color image;
converting the RGB signal into a CMY signal;
extracting a first image attribute from the CMY signal;
generating a signal including either of a luminance/chrominance difference signal and a lightness/chromaticity signal from the RGB signal;
extracting a second image attribute from the signal including either of a luminance/chrominance difference signal and a lightness/chromaticity signal; and
applying, based on the first image attribute and the second image attribute, an adaptive image processing to the signal including either of a luminance/chrominance difference signal and a lightness/chromaticity signal.

37. A computer product that makes a computer execute:
acquiring a RGB signal corresponding to a color image;
converting the RGB signal into a CMY signal;
extracting an image attribute from the CMY signal; and
applying, based on the image attribute, an adaptive image processing to the RGB signal.

38. A computer product that makes a computer execute:
acquiring a RGB signal corresponding to a color image;
converting the RGB signal into a CMY signal;
extracting an image attribute from the CMY signal; and
generating a signal including either of a luminance/chrominance difference signal and a lightness/chromaticity signal from the RGB signal;
applying, based on the image attribute, an adaptive image processing to the signal including either of a luminance/chrominance difference signal and a lightness/chromaticity signal.

39. A computer product that makes a computer execute:
acquiring a RGB signal corresponding to a color image;
extracting a first image attribute from the RGB signal;
converting the RGB signal into a CMY signal;
extracting a second image attribute from the CMY signal; and
applying, based on the first image attribute and the second image attribute, an adaptive image processing to the RGB signal.

40. A computer product that makes a computer execute:
acquiring a RGB signal corresponding to a color image;
extracting a first image attribute from the RGB signal;
converting the RGB signal into a CMY signal;
extracting a second image attribute from the CMY signal;
generating a signal including either of a luminance/chrominance difference signal and a lightness/chromaticity signal from the RGB signal; and
applying, based on the first image attribute and the second image attribute, an adaptive image processing to the signal including either of a luminance/chrominance difference signal and a lightness/chromaticity signal.

41. A computer product that makes a computer execute:
acquiring a RGB signal corresponding to a color image;
converting the RGB signal into a CMY signal;
extracting a first image attribute from the CMY signal;
generating a signal including either of a luminance/chrominance difference signal and a lightness/chromaticity signal from the RGB signal;
extracting a second image attribute from the signal including either of a luminance/chrominance difference signal and a lightness/chromaticity signal; and
applying, based on the first image attribute and the second image attribute, an adaptive image processing to the RGB signal.

42. A computer product that makes a computer execute:
acquiring a RGB signal corresponding to a color image;
converting the RGB signal into a CMY signal;
extracting a first image attribute from the CMY signal;
generating a signal including either of a luminance/chrominance difference signal and a lightness/chromaticity signal from the RGB signal;
extracting a second image attribute from the signal including either of a luminance/chrominance difference signal and a lightness/chromaticity signal; and
applying, based on the first image attribute and the second image attribute, an adaptive image processing to the signal including either of a luminance/chrominance difference signal and a lightness/chromaticity signal.
